(19) United States
(12) Patent Application Publication
(10) Pub. No.: US 2003/0091291 A1
(43) Pub. Date: May 15, 2003

(54) Smoothing facets on an optical component

(76) Inventors: Sam Keo, San Diego, CA (US); Ruth Mary Cherian, Pasadena, CA (US); Sophorn Seng, Gardena, CA (US); Elvia Rios, Inglewood, CA (US); Delaney Chan, Long Beach, CA (US); Chi Wu, San Marino, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/001,252

(22) Filed: Nov. 15, 2001

(51) Int. Cl. G02B 6/26

(52) U.S. Cl. 385/52

(57) ABSTRACT

A method of smoothing facets on optical components is disclosed. The method includes forming a plurality of optical components into a block of optical components. The method also includes smoothing one or more sides of the block of optical components. The one or more smoothed sides are at least partially defined by edges of the optical components. In some instances, the edges of the optical components that define the side of the block include one or more waveguide facets.

### FIELD OF THE INVENTION

The invention relates to optical components. In particular, the invention relates to smoothing facets positioned on the waveguides of optical components.

### BACKGROUND OF THE INVENTION

Optical networks employ a variety of optical components such as switches, demultiplexers, isolators, modulators and attenuators. Each optical component typically includes one or more waveguides for carrying the light signals to be processed by the optical component. These waveguides often end at a facet positioned at an edge of the optical component. Facets are often coupled with optical fibers that carry light signals to and/or from the optical component. Accordingly, light signals are often transmitted through a facet.

A light signal transmitted through a facet can be reflected by the facet. Reflected light signals are a source of optical loss and noise. The amount of reflection that occurs at the facet increases as the roughness of the facet increases. Lapping or polishing techniques can be employed to smooth a facet positioned at an edge of an optical component in order to improve the optical performance of the facet. The currently available polishing and techniques are inefficient and not suitable for large scale production of optical components. As a result, there is a need for improved facet smoothing techniques.

### SUMMARY OF THE INVENTION

The invention relates to a method of smoothing facets on optical components. The method includes forming a plurality of optical components into a block of optical components. The method also includes smoothing one or more sides of the block of optical components. The one or more smoothed sides are at least partially defined by edges of the optical components. In some instances, the edges of the optical components that define the one or more smoothed sides of the block include one or more waveguide facets.

The invention also relates to a system for holding a block of optical components to be smoothed. The system includes a base having a recess configured to receive the block of optical components. A bottom of the recess extends to an external side of the base such that a block of optical components positioned on the bottom of the recess can extend from within the recess past the external side of the recess. The system also includes a cover configured to be positioned over the recess so as to clamp the block of optical components between the cover and the base.

The invention also relates to a method of forming a block of optical components. The method includes positioning a plurality of optical components adjacent to one another with a bonding medium positioned between adjacent optical components. The method also includes aligning at least one edge of the optical components.

The invention also relates to a jig for aligning an edge of optical components. The jig includes a base having an optical component positioning region for positioning a block of optical components. The jig also includes two or more alignment members adjacent to the optical component positioning region. At least one of the alignment members is movable relative to one or more alignment members positioned on an opposing side of the optical component positioning region.

### BRIEF DESCRIPTION OF THE FIGURES

FIG. 1A is a top view of an optical component having a facet that can be smoothed according to the present invention.

FIG. 1B is a top view of a portion of the optical component shown in FIG. 1A.

FIG. 1C is a side view of the optical component shown in FIG. 1B taken in the direction of the arrow labeled A.

FIG. 1D is a cross section of an optical component taken along a longitudinal axis of a waveguide.

FIG. 2A is a perspective view of a jig for aligning a plurality of optical components.

FIG. 2B is a top view of the alignment jig shown in FIG. 2A.

FIG. 2C is a side view of the alignment jig shown in FIG. 2B taken in the direction of the arrow labeled A in FIG. 2B.

FIG. 3A through FIG. 3F illustrate a method of operating an alignment jig so as to form a block of optical components having one or more aligned edges.

FIG. 4A is a top view of the base of a holder that is suitable for holding a block of optical components while smoothing a side of the block.

FIG. 4B is a side view of the base shown in FIG. 4A taken in the direction of the arrow labeled A.

FIG. 4C is a cross section of the base shown in FIG. 4A taken along the line labeled B.

FIG. 4D is a side view of the base shown in FIG. 4B taken in the direction of the line labeled C.

4E is a side view of the base shown in FIG. 4B taken in the direction of the line labeled D.

FIG. 4F is a top view of a cover that is suitable for use with the base illustrated in FIG. 4A through FIG. 4E.

FIG. 4G is a side view of the cover shown in FIG. 4F taken in the direction of the arrow labeled A.

FIG. 4H is a side view of the cover shown in FIG. 4F taken in the direction of the arrow labeled B.

FIG. 4I is bottom view of the cover illustrated in FIG. 4F.

FIG. 5A through FIG. 5D illustrate a method of operating a holder so as to hold a block of optical components.

FIG. 6A is a side view of a polishing jig that is suitable for holding the holder during smoothing of the block of optical components.

FIG. 6B is a cross section of the polishing jig shown in FIG. 6A taken along the line labeled A.

FIG. 7A through FIG. 7C illustrate a method of operation of a polishing jig so as to polish one or more sides of the block of optical components.

FIG. 8A is a top view of a holder that is suitable for forming a facet angled at less than ninety degrees relative to the direction of propagation of light signals along a waveguide.

FIG. 8B is a cross section of the base shown in FIG. 8A along the line labeled A with a cover positioned over the base.

FIG. 9A through FIG. 9C illustrate a method of operating the holder illustrated in FIG. 8A and FIG. 8B so as to form a facet angled at less than ninety degrees relative to the direction of propagation of light signals along a waveguide.

FIG. 10A through FIG. 10B illustrate a method of operating another embodiment of a holder so as to form a facet angled at less than ninety degrees relative to the direction of propagation of light signals along a waveguide.

### DETAILED DESCRIPTION OF THE PREFERRED EMBODIMENT

The invention relates to smoothing facets on optical component. A plurality of optical components is formed into a block. The block is formed such that the edges of the optical components define one or more sides of the block. One or more sides of the block defined by edges of the optical components are smoothed. The edges of the optical components that define the one or more smoothed side can include waveguide facets. As a result, smoothing the side of the block also serves to smooth the facets of the optical components. Hence, the facets on a plurality of optical components can be concurrently smoothed. The ability to concurrently smooth the facets on a plurality of optical components makes smoothing of the facets of optical components a viable step in large scale fabrication of optical components.

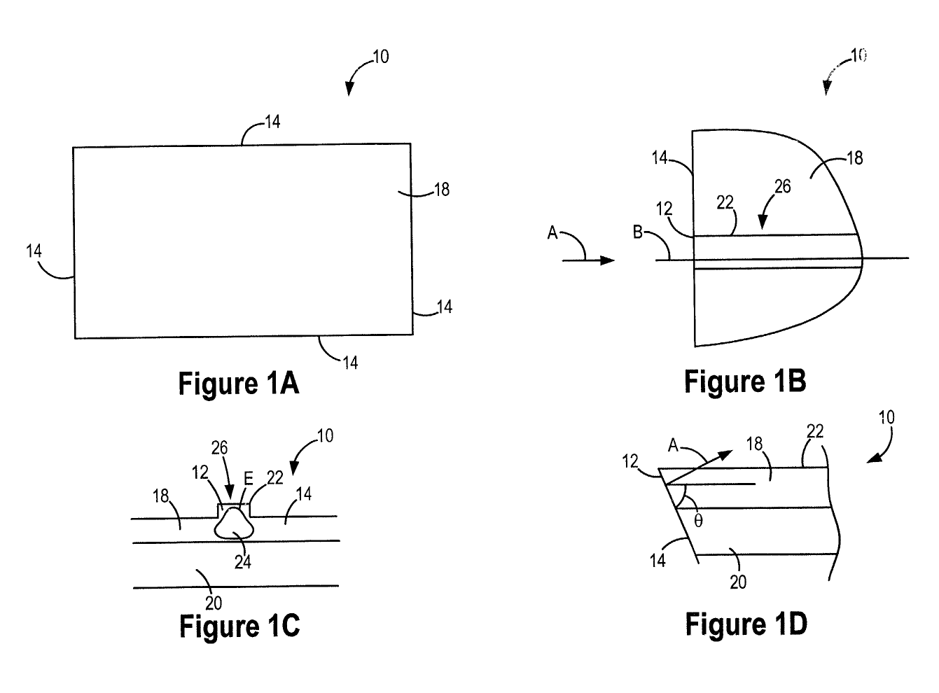

FIG. 1A through FIG. 1D illustrate an example of an optical component 10. A facet 12 is positioned at an edge 14 of the optical component 10. FIG. 1A is a top view of the optical component 10. FIG. 1B is a top view of a portion of the optical component 10 shown in FIG. 1A. FIG. 1C is a side view of the optical component 10 shown in FIG. 1B taken in the direction of the arrow labeled A. Although the edges 14 of the optical component 10 is illustrated as defining a rectangular shape, the optical component 10 can have edges 14 that define a variety of different geometries and can include one or more curved edges 14.

The component 10 includes a light transmitting medium 18 formed over a base 20. The light transmitting medium 18 includes a ridge 22 that defines a portion of the light signal carrying region 24 of a waveguide 26. Suitable light transmitting media include, but are not limited to, silicon, polymers, silica, SiNₓ, LiNbO₃, GaAs and InP. The base 20 is configured to reflect light signals from the light signal carrying region 24 back into the light signal carrying region 24. As a result, the base 20 also defines a portion of the light signal carrying region 24. The line labeled E illustrates the profile of a light signal carried in the light signal carrying region 24.

The waveguide 26 ends at a facet 12 positioned at an edge 14 of the optical component 10. Light signals can enter and/or exit the waveguide 26 through the facet 12. Reflection of a light signal at the facet 12 is a source of optical loss and noise associated with the optical component 10. A smoother facet 12 produces less reflection than a rough facet 12. As a result, a smooth facet 12 can reduce the amount of optical loss and noise associated with an optical component 10.

The facet 12 can be angled at less than ninety degree relative to the direction of propagation of light signals traveling along the waveguide 26. For instance, FIG. 1D is a cross section of the optical component 10 taken along the longitudinal axis of a waveguide 26. FIG. 1D could be a cross section of the optical component 10 shown in FIG. 1B taken at the line labeled B. The facet 12 illustrated in FIG. 1D is positioned at an angle φ relative to the direction of propagation of light signals along the waveguide 26. As illustrated by the arrow labeled A, a light signal reflected at the facet 12 can be reflected out of the waveguide 26. As a result, the reflected light signal is not a source of resonance in the waveguide 26. Suitable angles, 4, include, but are not limited to, angles in a range from 45°-89°, 70°-88°, 80°-85° or 82°-84°.

An example of a method for smoothing the facets 12 of an optical component 10 includes forming a plurality of optical components 10 into a block 60. One or more sides of the block 60 are smoothed such that facets 12 positioned at the smoothed side of the block 60 are also smoothed.

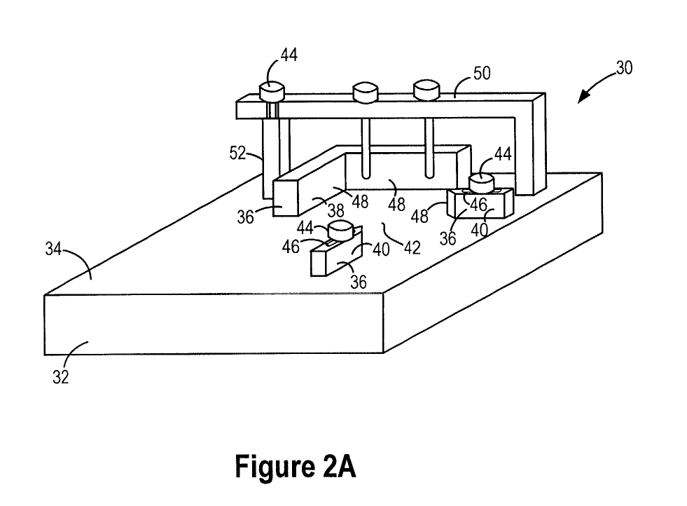

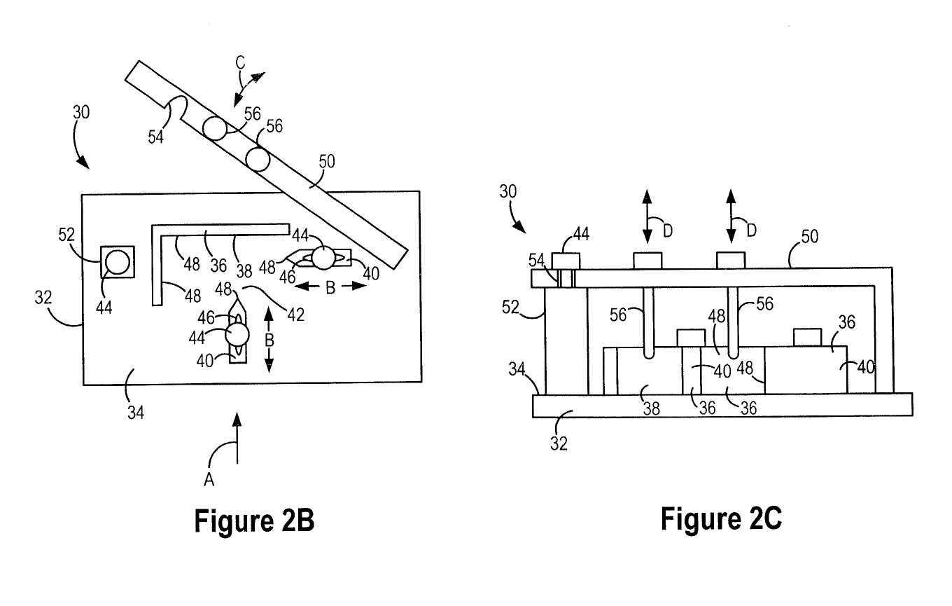

FIG. 2A through FIG. 2C illustrate an alignment jig 30 that is suitable for forming a block of optical components 10 having one or more aligned edges 14. FIG. 2A is a perspective view of the alignment jig 30 and FIG. 2B is a top view of the alignment jig 30. FIG. 2C is a side view of the alignment jig 30 taken in the direction of the arrow labeled A in FIG. 2B.

The alignment jig 30 includes a base 32 having a platform 34. A plurality of alignment members 36 are positioned adjacent to a component positioning region 42. For instance, the base 32 includes a fixed alignment member 38 and a plurality of mobile alignment members 40. The fixed alignment member 38 and mobile alignment members 40 are positioned on opposing sides of an optical component positioning region 42. As will become evident below, optical components 10 are positioned in the optical component positioning region 42 during operation of the alignment jig so as to align one or more edges of the optical components.

The fixed alignment member 38 is immobilized relative to the base 32. The fixed alignment member 38 can be integral with the base 32 or can be attached to the base 32. As will become evident below, a portion of the fixed alignment member 38 has a contour that is complementary to one or more sides of the optical components 10 so optical components 10 can be positioned against the fixed alignment member 38.

The mobile alignment members 40 can be move relative to an alignment member positioned on an opposing side of the component positioning region. Each mobile alignment member 40 includes an immobilizing device 44 for immobilizing the mobile alignment member 40 relative to the base 32. A suitable immobilizing device 44 is a screw that screws into the base 32. The screw can pass through an opening 46 in the mobile alignment members 40. When the screw is tightened against the mobile alignment members 40, the mobile alignment member 40 is immobilized relative to the platform 34. When the screw is loosened, the mobile alignment member 40 is mobile relative to the platform 34 as shown by the arrows labeled B. Accordingly, the mobile alignment member 40 can be moved to a particular location on the platform 34 and locked into position on the platform 34.

The alignment members 36 each include a component contact region 48. As will be shown in more detail below, the component contact region 48 of an alignment member 36 is the region of the alignment member 36 that contacts the optical components 10 being aligned by the alignment jig 30. The component contact region 48 of alignment members 36 positioned on opposing sides of the components positioning region 42 are parallel to one another.

An arm 50 and an arm support 52 are positioned over the platform 34. The arm 50 can be rotated about an axis as illustrated by the arrow labeled C. The arm 50 can be moved into contact with the arm support 52. The arm support 52 includes an immobilizing device 44 that can be employed to immobilize the arm 50 relative to the arm support 52. An example of an immobilizing device 44 is a screw that screws into the arm support 52. The arm 50 can include a recess 54. When the arm 50 is in contact with the arm support 52, the screw can be received in the recess 54. The screw can be tightened against the arm 50 to immobilize the arm 50 relative to the platform 34.

The arm 50 includes one or more alignment devices 56. The one or more alignment devices 56 can be moved relative to the platform 34 as indicated by the arrows labeled D in FIG. 1C. The one or more alignment devices 56 are positioned on the arm 50 so as to be positioned over the optical component positioning region 42 when the arm 50 is positioned in contact with the arm support 52. Accordingly, the one or more alignment devices 56 can apply a downward pressure to optical components 10 positioned in the optical component positioning region 42. A example of a suitable alignment devices 56 is a screw that passes through the arm 50 and that can be threaded into the arm 50. Accordingly, loosening the screw moves the end of the screw away from the optical component positioning region 42 and tightening the screw moves the end of the screw toward the optical component positioning region 42. The screw can be tightened enough to apply pressure to optical components 10 positioned in the optical component positioning region 42.

Although the component contact regions 48 illustrated above are shown as being substantially perpendicular to the base 32, the component contact regions 48 can be non-perpendicular while component contact regions 48 on opposing sides of the component positioning region 42 are parallel. This arrangement causes the edges 14 of the optical components 10 to be aligned at an angle.

Although the alignment jig 30 shows one mobile alignment member 40 positioned adjacent to a side of the component positioning region 42, more than one mobile alignment member 40 can be positioned adjacent to a side of component positioning region 42.

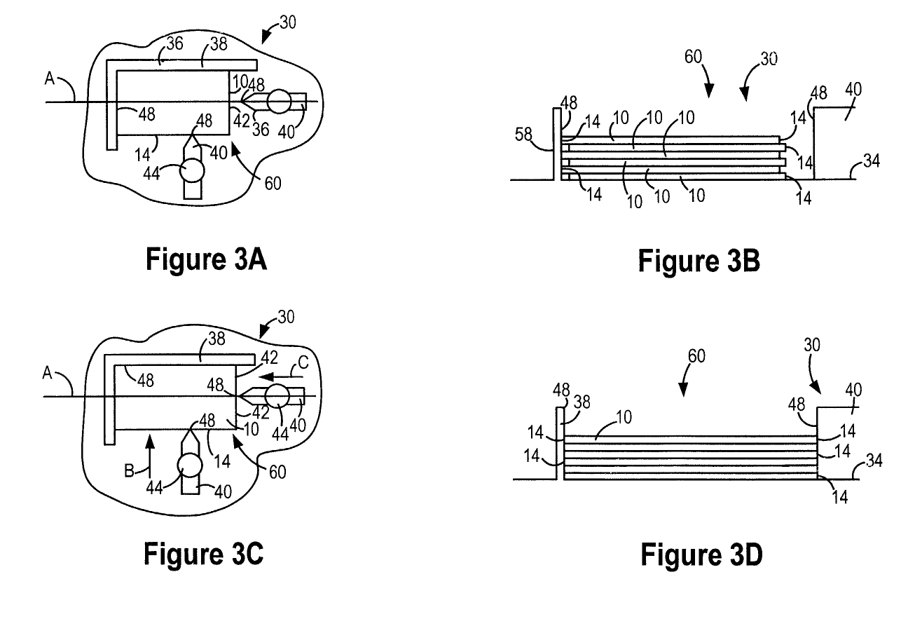

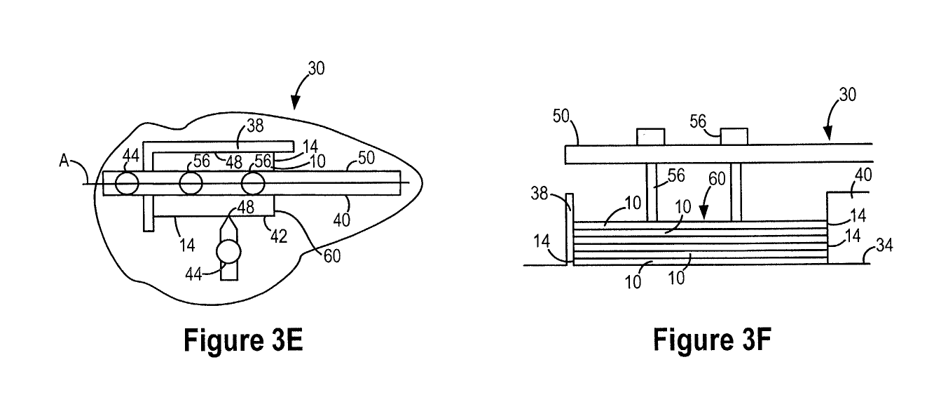

FIG. 3A through FIG. 3F illustrate a method of operating the alignment jig 30 so as to form a block 60 of optical components 10 having one or more aligned edges. The alignment jig 30 is heated to a temperature sufficient for melting a bonding medium for bonding the optical components 10 together. A suitable bonding medium includes, but is not limited to, wax such as quartz wax or white wax. When the bonding medium is quartz wax, a suitable temperature for the alignment jig 30 is about 100° C. and when the bonding medium is white wax, a suitable temperature for the alignment jig 30 is about 55-59° C. A suitable material for the alignment jig 30 includes, but is not limited to, aluminum. An alignment jig 30 constructed from a material such as aluminum can be heated to the desired temperature by placing the alignment jig 30 on a heating plate.

A plurality of optical components 10 are positioned in the optical component positioning region 42 as illustrated in FIG. 3A and FIG. 3B. FIG. 3A is a top view of the alignment jig 30 and FIG. 3B is a cross section of the alignment jig 30 shown in FIG. 3A taken at the line labeled A. As shown in FIG. 3A and FIG. 3B, the optical components 10 each have about the same geometry and can be positioned in the optical component positioning region 42 without the edges 14 of the optical components 10 being aligned. The optical components 10 can be positioned on the platform 34 sequentially. A layer of bonding medium can be positioned on each optical component 10 before another optical component 10 is positioned on the platform 34. Accordingly, the bonding medium is positioned between the optical components 10. The bonding medium can be positioned on the optical components 10 in a fluid state or in a solid state.

One or more of the optical components 10 can be a dummy optical component. For instance, the top optical component 10 and/or the bottom optical component 10 can be a dummy optical component. A suitable dummy optical component includes a silicon substrate having a geometry that matches the geometry of the optical components 10.

Although FIG. 3A through FIG. 3F illustrate the block 60 including six optical components 10, the block 60 can include two or more optical components 10. A suitable number of optical components for the block include, but are not limited to, four or more optical components, seven or more optical components, 10 or more optical components, and 14 or more optical components.

The mobile alignment members 40 are moved into contact with the optical components 10 as shown in FIG. 3C and FIG. 3D. FIG. 3C is a top view of the alignment jig 30 and FIG. 3D is a cross section of the alignment jig 30 shown in FIG. 3C taken at the line labeled A. One of the mobile alignment members 40 is moved in the direction of the arrow labeled B and the other mobile alignment members 40 is moved in the direction of the arrow labeled C. The movement of the mobile alignment members 40 drives the optical components 10 against the fixed alignment member 38. Because the optical components 10 are about the same size and because the component contact regions 48 are parallel, the movement of the mobile alignment member 40 causes the edges 14 of the optical components 10 to line up along the contact regions 48 of the fixed alignment member 38 and the mobile alignment members 40. As a result, the movement of the mobile alignment member 40 causes the edges 14 of the optical components 10 to be aligned with one another.

The shape and positioning of the fixed alignment member prevents the block of optical components from twisting or rotating in response to the forces created by movement of the mobile alignment member. Although a one piece fixed alignment member is shown, the function of the fixed alignment member 38 can be achieved with a plurality of alignment members 36 positioned adjacent to the component positioning region so as to provide the functions of the single fixed alignment member.

The arm 50 is positioned in contact with the arm support 52 as shown in FIG. 3E and FIG. 3F. FIG. 3E is a top view of the alignment jig 30 and FIG. 3F is a cross section of the alignment jig 30 shown in FIG. 3E taken at the line labeled A. The immobilizing device 44 on the arm support 52 is engaged so as to immobilize the arm 50 relative to the platform 34. The alignment devices 56 are engaged so as to apply a downward pressure on the optical components 10. Further, the alignment devices 56 are engaged so the distance between the end of each alignment device 56 and the platform 34 is the same. For instance, when the alignment device 56 is a screw that is threaded into the arm 50, each alignment device 56 can be threaded the same distance into the arm 50. Because the distance between the end of each alignment device 56 and the platform 34 is the same, the thickness of the block 60 under one of the alignment devices 56 is the same as the thickness of the block 60 under the other alignment device 56. As a result, the optical components 10 are substantially parallel to each other.

The alignment jig 30 can be allowed to cool and the block 60 can be removed from the alignment jig 30. Alternatively, the block 60 can be removed before the alignment jig 30 is cooled. Cooling of the block 60 allows the bonding medium to bond the optical components 10 together. As a result, the optical components 10 can be handled as a block 60 after cooling of the optical components 10.

Before the alignment jig 30 is cooled, the immobilizing devices 44 can be engaged so as to immobilize the mobile alignment members 40 relative to the base 32. Engaging the immobilizing devices 44 allows the block 60 of optical components 10 to retain the desired shape during the cooling process. The immobilizing devices 44 can be engaged at other times during formation of the block 60. For instance, the immobilizing devices 44 can be engaged before the arm 50 is positioned over the component positioning region 42. Further, the immobilizing devices 44 associated with each mobile alignment member can be engaged after moving the mobile alignment member into contact with the optical components.

Although the alignment jig 30 of FIG. 3A through FIG. 3F shows a fixed alignment member 38, the alignment of the optical component edges 14 can be achieved with mobile alignment members 40 positioned on opposing sides of the component positioning region 42. For instance, one of the mobile alignment members 40 can be immobilized using an immobilizing device 44 and another mobile alignment member 40 employed to drive the optical components 10 against the immobilized mobile alignment member 40. Alternatively, mobile alignment members 40 on opposing sides of the optical components 10 can be moved toward one another.

Although FIG. 2A through FIG. 3F illustrate the alignment jig 30 employed to align the edges 14 on each side of the optical components 10, there may be circumstances where it is desired to align the edges 14 on only one side of the optical components 10. As a result, alignment members 36 need not be positioned adjacent to each side of the component positioning region 42. For instance, the alignment jig 30 illustrated in FIG. 2A can include a single mobile alignment member 40. Operating an alignment jig 30 having a single mobile alignment member 40 results in alignment of the optical component edges 14 on at least one side of the block 60.

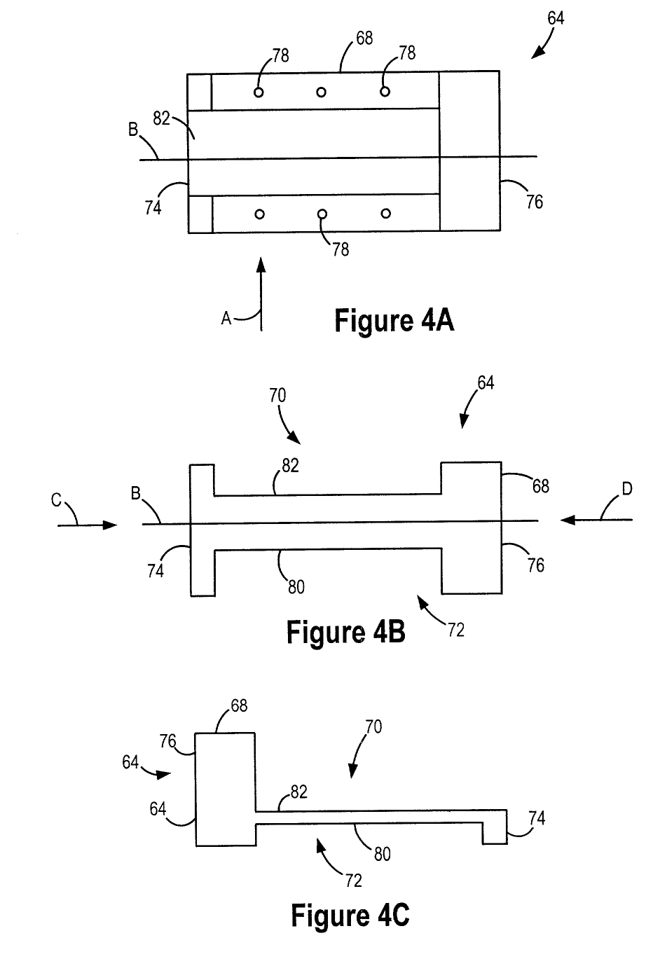

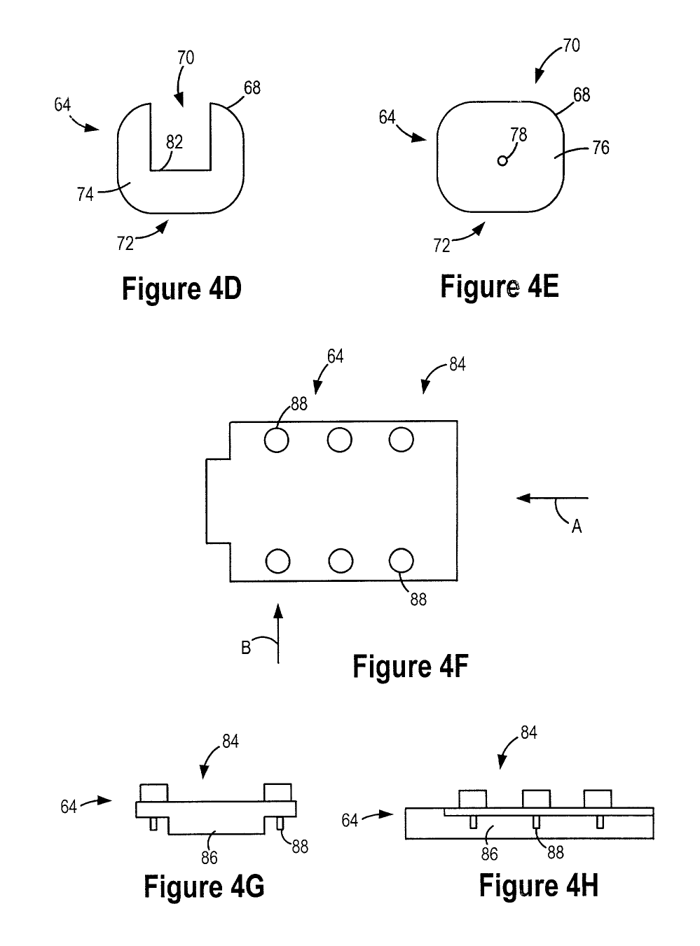

FIG. 4A through FIG. 4I illustrate an example of a holder 64 for holding a block 60 of optical components 10 while smoothing a portion of the block 60. The holder 64 includes a cover configured to be moved relative to a base 68. FIG. 4A through FIG. 4E illustrate different views of a suitable base 68. FIG. 4A is a top view of the base 68. FIG. 4B is a side view of the base 68 shown in FIG. 4A taken in the direction of the arrow labeled A. FIG. 4C is a cross section of the base 68 shown in FIG. 4A taken along the line labeled B. FIG. 4D is a side view of the base 68 shown in FIG. 4B taken in the direction of the line labeled C. FIG. 4E is a side view of the base 68 shown in FIG. 4B taken in the direction of the line labeled D.

The base 68 includes a top side 70, a bottom side 72, a front side 74 and a back side 76. The top side 70 includes a plurality of threaded openings 78 and the back side 76 includes one or more threaded openings 78. The bottom side 72 of the base 68 includes a first recess 80. The first recess 80 reduces the weight of the holder 64.

The top side 70 of the base 68 includes a second recess 82. The bottom of the second recess 82 extends to the front side 74 of the holder 64. The second recess 82 has a shape that is complementary to the shape of a portion of the block 60 so the block 60 can be positioned in the second recess 82 without substantial movement of the block 60 relative to the second recess 82.

FIG. 4F through FIG. 4I illustrate different views of a cover 84 that is suitable for use with a base 68 constructed according to FIG. 4A through FIG. 4E. FIG. 4F is a top view of the cover 84. FIG. 4G is a side view of the cover 84 shown in FIG. 4F taken in the direction of the arrow labeled A. FIG. 4H is a side view of the cover 84 shown in FIG. 4F taken in the direction of the arrow labeled B. FIG. 4I is bottom view of the cover 84 illustrated in FIG. 4F.

A bottom side 72 of the cover 84 includes a ridge 86. The ridge 86 is shaped such that the cover 84 can be positioned on the base 68 with the ridge 86 positioned in the second recess 82. Additionally, the ridge 86 can have a shape that is complementary to the shape of the second recess 82. The complementary shape of the ridge 86 reduces movement of the ridge 86 relative to the second recess 82 when the cover 84 is positioned on the base 68.

The cover 84 also includes a plurality of couplers 88 for coupling the cover 84 with the base 68. Suitable couplers 88 include, but are not limited to, screws configured to be screwed into the threaded openings 78 in the top side 70 of the holder 64. The screws extend through the cover 84 such that an end of the screw is positioned adjacent to the ridge 86.

Although the cover 84 is shown as being detached from the base 68, the cover 84 can be coupled with the base 68. For instance, the cover 84 can be hinged to the base 68.

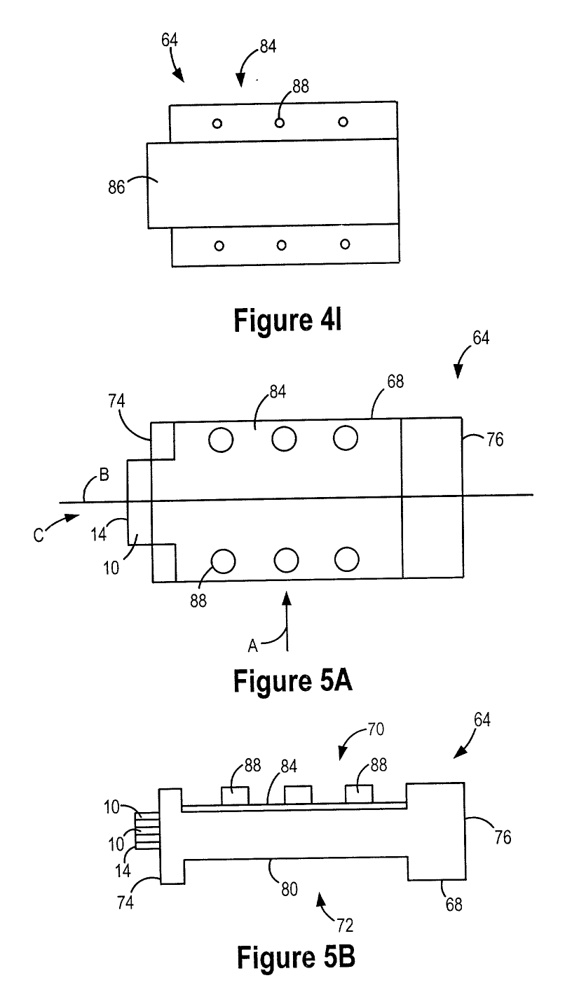

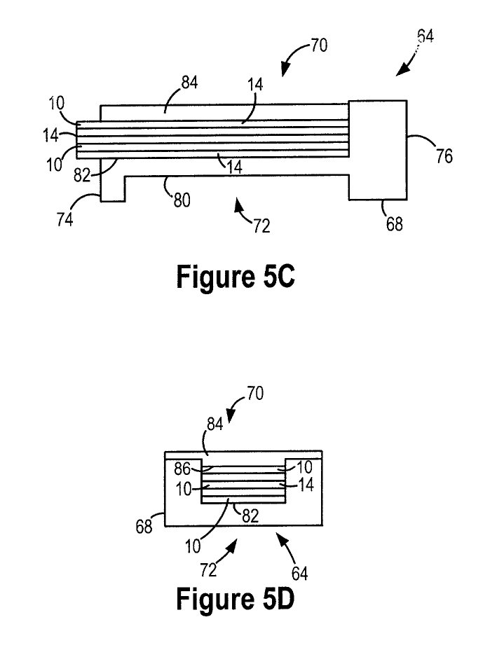

FIG. 5A through FIG. 5D illustrate operation of the holder 64 to hold a block 60 of optical components 10. FIG. 5A is a top view of a holder 64 holding a block 60 of optical components 10. FIG. 5B is a side view of the holder 64 shown in FIG. 5A taken in the direction of the arrow labeled A. FIG. 5C is a cross section of the holder 64 shown in FIG. 5A taken along the line labeled B. FIG. 5D is a side view of the holder 64 shown in FIG. 5A taken in the direction of the arrow labeled C.

During operation of the holder 64, the block 60 of optical components 10 are positioned in the second recess 82 in the top of the base 68. The block 60 is positioned against a back side of the second recess 82. Because the second recess 82 has a shape that is complementary to the shape of the block 60, the block 60 fits in the second recess 82 with little freedom to move relative to the second recess 82. The cover 84 is positioned on the base 68 with the ridge 86 positioned in the second recess 82. The couplers 88 are screwed into the threaded openings 78 on the top side 70 of the base 68 until the block 60 is clamped between the cover 84 and the bottom of the second recess 82. If the block 60 is too narrow to be clamped between the cover 84 and the bottom of the second recess 82, shims can be employed between the block 60 and cover 84 and/or between the block 60 and/or the bottom of the second recess 82.

At least a portion of a side of the block 60 extends from the front side 74 of the holder 64 as is evident in FIG. 5A through FIG. 5C. As will be shown in more detail below, the exposed side of the block 60 is the side of the block 60 to be smoothed. Accordingly, the block 60 is positioned in the holder 64 so the exposed portion of the block 60 includes facets 12 to be smoothed.

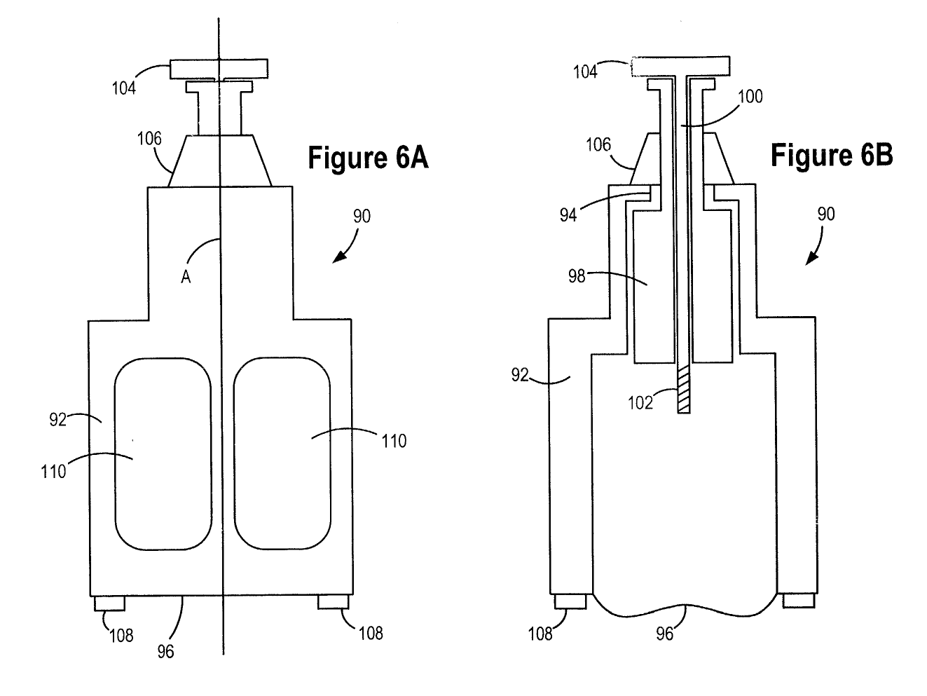

FIG. 6A and FIG. 6B illustrate a polishing jig 90 that is suitable for holding the holder 64 during smoothing of the block 60 of optical components 10. FIG. 6A is a side view of the polishing jig 90. FIG. 6B is a cross section of the polishing jig 90 shown in FIG. 6A taken along the line labeled A. The polishing jig 90 includes a frame 92 defining a chamber for holding the holder 64. The frame 92 includes an upper opening 94 and a lower opening 96. The frame 92 holds a carriage 98 that extends through the upper opening 94. The carriage 98 can be moved up and down within the frame 92.

A rod 100 extends through the carriage 98. The rod 100 includes an end with threads 102 and an end with a head 104. The threads 102 on the end of the rod 100 are complementary to the threads of the threaded opening 78 on the back side 76 of the holder 64. The head 104 can be turned to rotate the rod 100 in the carriage 98.

A micrometer 106 is positioned over the upper opening 94. Gravity holds the micrometer 106 against the frame 92. The micrometer 106 can be threaded onto the carriage 98. Rotating the micrometer 106 in a first direction around the carriage 98 moves the carriage 98 up relative to the frame 92 while rotating the micrometer 106 in a second direction around the carriage 98 moves the carriage 98 down relative to the frame 92.

Feet 108 are positioned at a bottom of the frame 92. During the smoothing process, the feet 108 are positioned on the smoothing mechanism. For instance, if the smoothing process is polishing, the feet 108 can be positioned on a polishing wheel during the smoothing process. The feet 108 are constructed from a material that resists breaking down in response to the smoothing process. For instance, if the smoothing process is polishing, the feet 108 can be constructed from diamond.

The frame 92 can optionally include one or more openings 110 through the side of the frame 92. The one or more openings 110 can be selected to reduce the weight of the polishing jig 90.

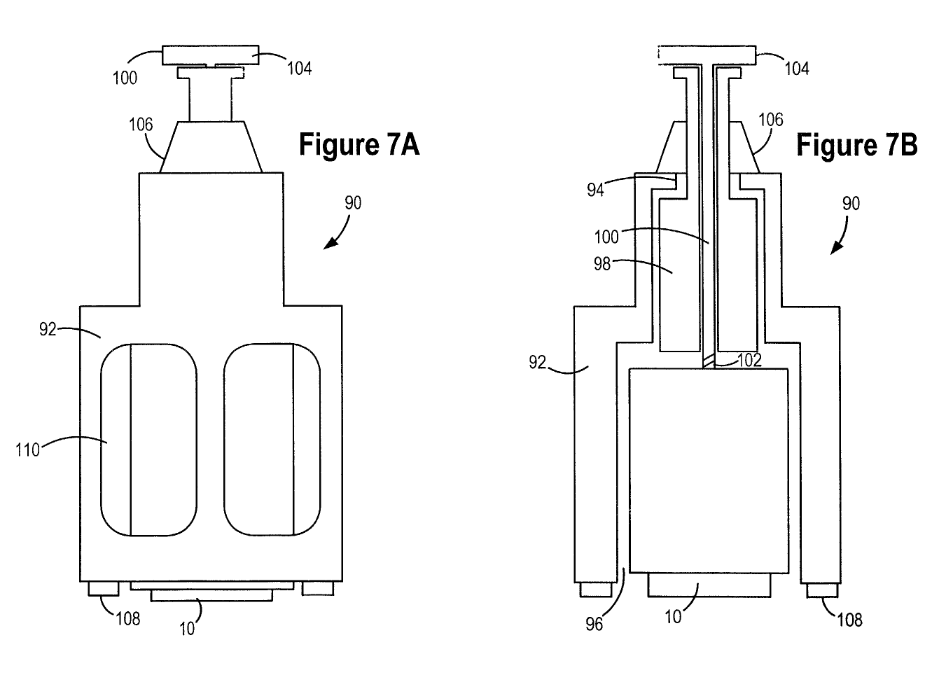

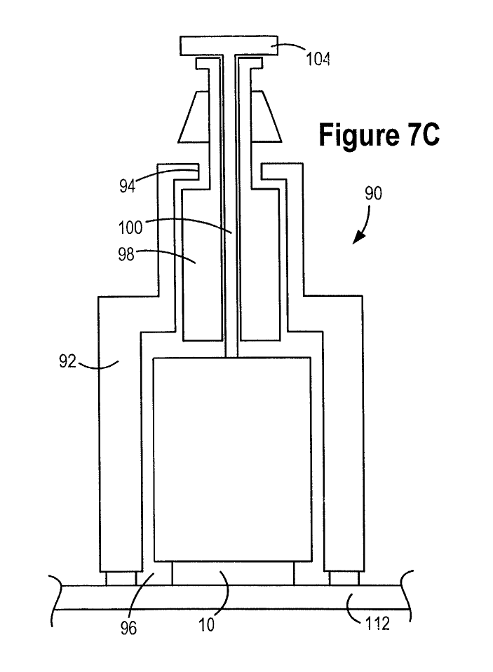

FIG. 7A through FIG. 7C illustrate operation of the polishing jig 90. FIG. 7A is a side view of the polishing jig 90 holding the holder 64. FIG. 7B is a cross section of the polishing jig 90 illustrated in FIG. 7A.

During operation of the polishing jig 90, the holder 64 is positioned in the frame 92 such that the exposed portion of the block 60 extends through the lower opening 96. The threaded end of the rod 100 is threaded into the threaded opening 78 in the back side 76 of the holder 64. As a result, the holder 64 is immobilized relative to the carriage 98.

The micrometer 106 is adjusted so as to move the carriage 98 up or down in the frame 92. The micrometer 106 is adjusted so the exposed portion of the block 60 extends a desired distance past the feet 108. The distance of the exposed region past the feet 108 is the total amount of the block 60 can be removed from the block 60 during the smoothing process. For instance, when the block 60 extends 2 μm past the feet 108 at most 2 μm can be removed from the block 60 as a result of the smoothing process.

The exposed portion of the block 60 is smoothed. Suitable techniques for smoothing the block 60 include, but are not limited to, polishing, buffing and lapping. The polishing jig 90 is set on a smoothing device 112 as illustrated in FIG. 7C. Suitable smoothing devices 112 include, but are not limited to, polishing wheels, buffing wheels and lapping wheels. A suitable polishing wheel includes, but is not limited to, the lapping and polishing equipment manufactured by South Bay Technology, Inc. located in San Clemente, Calif.

In FIG. 7C, the carriage 98 shifts upward in the frame 92 until the feet 108 and the exposed portion of the block 60 rest on the smoothing device 112. The weight of the carriage 98 on the block 60 pushes the block 60 onto the smoothing device 112. The smoothing device 112 moves under the block 60 and includes an abrasive material. The movement of the abrasive material relative to the exposed portion of the block 60 serves to smooth the exposed portion of the block 60. Smoothing of the exposed portion of the block 60 smoothes the facets 12 positioned on the exposed portion of the block 60.

The amount of smoothing that occurs depends on the selection of the abrasive material. The highest degree of smoothness can be achieved by moving from a coarse abrasive material toward a fine abrasive material. An example of a suitable smoothing scheme includes using a 30 μm grid abrasive material, followed by a 9 μm grid abrasive material, followed by a 6 μm grid abrasive material, followed by a 3 μm grid abrasive material, followed by a 1 μm grid abrasive material, followed by a 0.02 μm grid abrasive material. Suitable materials for the holder 64 and the polishing jig 90 are rigid enough to withstand the stresses of the smoothing process without substantially deforming. Suitable materials include, but are not limited to, stainless steel.

After a suitable level of smoothness is achieved, the holder 64 can be removed from the smoothing jig and the block 60 removed from the holder 64. The optical components 10 in the block 60 can be separated from one another. A suitable method for separating the optical components 10 from one another includes, but is not limited to, heating the block to a temperature that allows the optical components 10 to be physically separated. The separated optical components 10 can then be placed in a cleaning solvent. For example, when the bonding medium is a wax, a solvent such as OPTICLEAR employed to remove the wax.

When the optical components 10 in the block 64 have more than one edge with facets to be smoothed, the block 60 can be placed back in the holder 64 so a different side of the block is exposed before the optical components 10 are separated from one another. The newly exposed side can be smoothed as described above. As a result, the facets one more than one edge of the optical component can be smoothed. The block 60 can be removed from the holder 64, replaced in the holder 64 and smoothed until each sides where smoothing is desired is smoothed. Once the desired sides are smoothed, the optical components 10 can be separated from one another as described above.

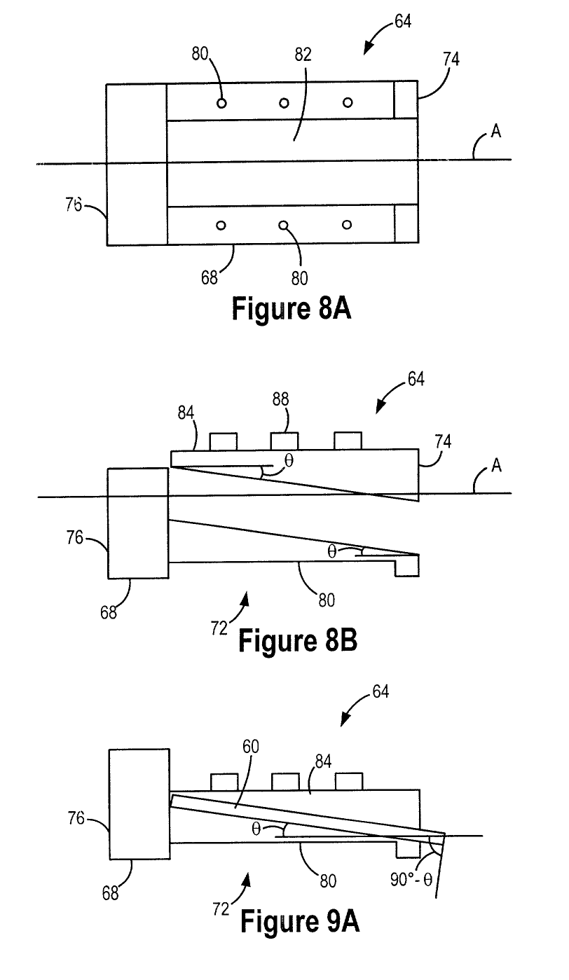

As noted above, the one or more facets 12 can be angled at less than ninety degrees relative to the direction of propagation of light signals along a waveguide. FIG. 8A and FIG. 8B illustrate a holder 64 that is suitable for forming a facet 12 angled at less than ninety degrees relative to the direction of propagation along a waveguide. FIG. 8A is a top view of the base 68 of the holder 64. FIG. 8B is a cross section of the base 68 shown in FIG. 8A along the line labeled A with a cover 84 positioned over the base 68.

The bottom of the second recess 82 and the portion of the cover 84 are angled relative to the longitudinal axis of the holder 64 at an angle, θ. The longitudinal axis of the holder 64 is the axis of the holder 64 that is to be positioned perpendicular to the abrasive material of the smoothing device 112. For instance, FIG. 7C illustrates the holder 64 positioned so the length of the holder 64 is vertical relative to the abrasive material of the smoothing device 112. The line labeled A in FIG. 8A or FIG. 8B is parallel to the length of the holder 64. Accordingly, the line labeled A in FIG. 8A or FIG. 8B denotes a longitudinal axis of the holder 64.

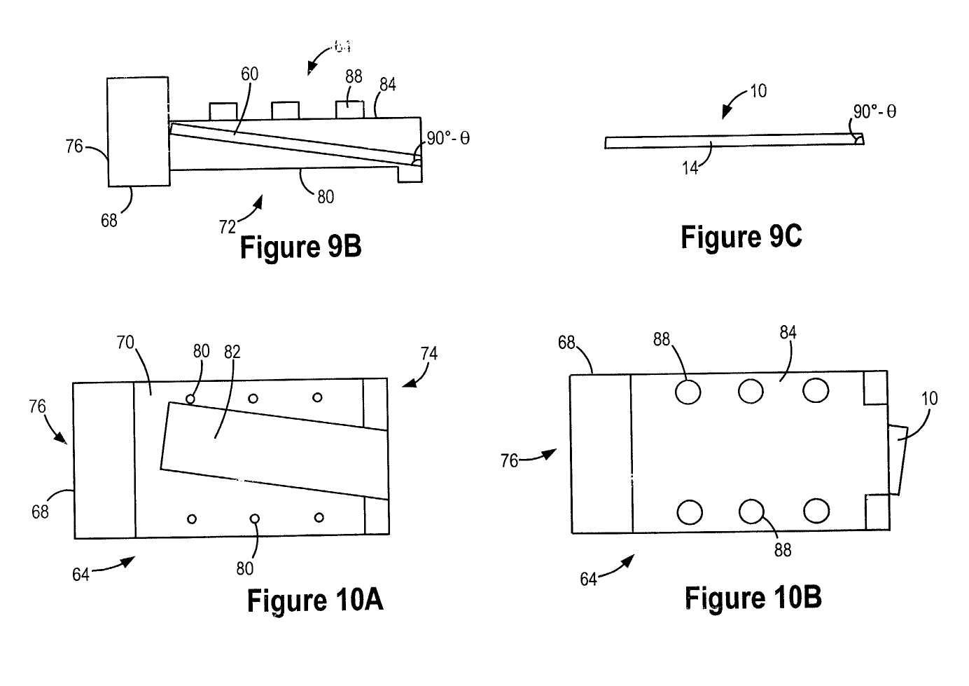

FIG. 9A through FIG. 9C illustrate operation of the holder 64 illustrated in FIG. 8A and FIG. 8B. The block 60 of optical components 10 are positioned in the second recess 82 as shown in FIG. 9A. The block 60 is positioned so at least a portion of the block 60 is in contact with a back of the second recess 82. The cover 84 is positioned on the base 68 with the ridge 86 positioned in the second recess 82. The couplers 88 are screwed into the threaded openings 78 on the top side 70 of the base 68 until the block 60 is clamped between the cover 84 and the bottom of the second recess 82. Because the bottom of the second recess 82 is angled at θ° relative to the longitudinal axis of the holder 64 at an angle θ, the exposed side of the block 60 is angled at θ° relative to the front side 74 of the holder 64. The front side 74 of the holder 64 is the portion of the holder 64 that is to be positioned parallel to the abrasive material of the smoothing device 112. Accordingly, the block 60 extends from the holder 64 such that a side of the block 60 is angled at 90°-θ relative to the longitudinal axis as shown in FIG. 9A.

The holder 64 is positioned in the polishing jig 90 and the exposed portion of the block 60 is smoothed. The block 60 is smoothed parallel to the front side 74 of the holder 64 as illustrated in FIG. 9B. Because the block 60 extends from the holder 64 at an angle at 90°-θ relative to the longitudinal axis, the exposed side of the block 60 is smoothed at 90°-θ. When the optical components 10 are separated, the edge 14 of the each optical component 10 also has an angle of 90°-θ as shown in FIG. 9C. The facets 12 positioned at the edge 14 of the optical component 10 are also formed at an angle 90°-θ. The angle 90°-θ is labeled as Φ in FIG. 1D. As a result, the holder 64 is designed with an angle θ that provides optical components 10 with the desired Φ.

Although FIG. 9A illustrates the second recess 82 formed so a gap is formed between a portion of the block 60 and the back of the second recess 82, the second recess 82 can be formed so the back of the second recess 82 is flush with the block 60.

FIG. 10A and FIG. 10B illustrate another embodiment of a holder 64 configured to form facets 12 angled at less than ninety degrees relative to a direction of propagation of light signals along a waveguide. The sides of the second recess 82 are formed at an angle, θ, relative to the longitudinal axis of the holder 64. When the block 60 is positioned in the second recess 82 as shown in FIG. 10B, the exposed portion of the block 60 extends from the holder 64 at an angle θ relative to the front side 74 of the holder 64. Because the smoothing process smoothes the block 60 parallel to the front side 74 of the holder 64, the exposed side of the block 60 is smoothed at an angle θ. When the optical components 10 are separated, the edge 14 of the each optical component 10 also has an angle of 90°-θ. The facets 12 positioned at the edge 14 of the optical component 10 are also formed at an angle 90°-θ. The angle 90°-θ is turned 90° relative to the angle labeled Φ in FIG. 1D, however, the angle 90°-θ will provide the same function as the angle labeled Φ. As a result, the holder 64 is designed with an angle θ that provides optical components 10 with the desired Φ.

As noted above, suitable values for the angle labeled Φ in FIG. 1D include, but are not limited to, angles less than 89°, 45°-89°, 70°-88°, 80°-85° or 82°-84°. Accordingly, suitable values for the angle labeled θ in FIG. 8A through FIG. 10B include, but are not limited to angles greater than 1°, 45°-1°, 2-20°, 5°-10° or 6-8°.

When more than one side of the block 60 is to be smoothed, the block 60 can be placed in different holders 64 during the smoothing of different sides. For instance, the block 60 can be placed in a holder 64 is suitable for forming a facet at a first angle relative to the direction of propagation along a waveguide during smoothing of a first side of the block 60. The block 60 can then be placed in a holder 64 suitable for forming a facet at a second angle relative to the direction of propagation along a waveguide during smoothing of a second side of the block 60.

Although the invention is disclosed in the context of optical components 10 having edges 14 that define a rectangular perimeter, the invention can be employed in conjunction with optical components 10 having edges 14 that define other shapes.

Although the optical components 10 disclosed above have a ridge waveguide, the optical components 10 can have other waveguide types including, but not limited to, buried channel waveguides and strip waveguides.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A apparatus for aligning an edge of optical components, comprising:
a base having an optical component positioning region for positioning a block of optical components, the block of optical components including a plurality of optical components positioned adjacent to one another; and
two or more alignment members adjacent to the optical component positioning region, at least one of the alignment members being movable relative to one or more alignment members positioned on an opposite side of the optical component positioning region.

2. The apparatus of claim 1, wherein the at least one movable alignment members is movable toward and away from an alignment member positioned on the opposing side of the optical component positioning region.

3. The apparatus of claim 1, wherein the at least one movable alignment members is configured to be moved so as to drive optical components positioned in the optical component positioning region against the alignment member positioned on the opposing side of the optical component.

4. The apparatus of claim 3, wherein the at least one movable alignment member and the alignment member positioned on the opposing side of the optical component are configured such that driving the optical components against the alignment member positioned on the opposing side of the optical component does not cause rotation of the optical components.

5. The apparatus of claim 1, wherein a component contact region of the a t least one movable alignment member is parallel to a component contact region of the alignment member positioned on the opposing side of the optical component positioning region, the component contact region of an alignment member being the portion of the alignment member configured to contact the optical components.

6. The apparatus of claim 5, wherein at least one alignment member contracts to a line that serves as the component contact region.

7. The apparatus of claim 5, wherein the component contact regions are substantially perpendicular to the base.

8. The apparatus of claim 1, wherein at least one alignment member is fixed relative to the base.

9. The apparatus of claim 1, wherein at least one alignment member is selected from a group consisting of a ridge extending from the base and a flange extending from the base.

10. The apparatus of claim 1, wherein at least one movable alignment member includes an immobilizing device for immobilizing the alignment member relative to the base.

11. The apparatus of claim 1, further comprising:
one or more alignment devices configured to apply a downward pressure to optical components positioned on the optical component positioning region.

12. The apparatus of claim 1, further comprising: a plurality of optical components positioned in the optical component positioning region.

13. The apparatus of claim 12, wherein a bonding medium is positioned between at least two adjacent optical components.

14. The apparatus of claim 1, wherein the apparatus is constructed of a metal.

15. The apparatus of claim 14, wherein the apparatus is constructed of aluminum.

16. A method of smoothing facets on optical components, comprising:
forming a plurality of optical components into a block of optical components; and
smoothing one or more sides of the block of optical components, the one or more smoothed sides being at least partially defined by edges of the optical components.

17. The method of claim 16, wherein at least one of the edges defining the one or more smoothed sides include at least one facet.

18. The method of claim 16, wherein more than one of the edges defining the one or more smoothed sides include at least one facet and smoothing the one or more sides includes concurrently smoothing facets included in different edges.

19. The method of claim 16, wherein smoothing the one or more sides includes an moving an abrasive material relative to the one or more sides with the one or more sides being in contact with the abrasive material.

20. The method of claim 16, wherein smoothing the one or more sides includes an operation selected from the group consisting of polishing, lapping and buffing.

21. The method of claim 16, wherein smoothing the one or more sides includes immobilizing the block in a recess of a holder such that a portion of the block to be smoothed remains exposed.

22. The method of claim 21, wherein the holder holds the block such that the exposed portion of the block includes a side positioned at an angle to the longitudinal axis of the holder, the angle of the side being less than 90 degrees.

23. The method of claim 22, wherein the angle is about 75 and 88 degrees.

24. The method of claim 22, wherein the side is at least partially defined by the edge of a plurality of optical components.

25. The method of claim 16, wherein forming the plurality of optical components into a block includes stacking optical components on top of one another with a bonding medium positioned between adjacent optical components.

26. The method of claim 16, further comprising:
cooling the block of optical components after forming the block of optical components.

27. The method of claim 16, wherein forming the plurality of optical components into a block includes positioning in the plurality of optical components in a apparatus.

28. The method of claim 27, wherein forming the plurality of optical components into a block includes elevating the temperature of the apparatus.

29. The method of claim 16, wherein forming the block of optical components includes aligning at least one edge of the optical components.

30. The method of claim 16, wherein smoothing one or more sides of the block includes

31. A method of forming a block of optical components from a plurality of optical components, comprising:
positioning a plurality of optical components adjacent to one another with a bonding medium positioned between adjacent optical components; and
aligning at least one edge of the optical components.

32. The method of claim 31, wherein positioning a plurality of optical components adjacent to one another includes positioning the plurality of optical components on an alignment apparatus.

33. The method of claim 32, wherein the temperature of the alignment apparatus is elevated above room temperature before the plurality of optical components are positioned on the alignment apparatus.

34. The method of claim 32, wherein positioning the plurality of optical components on an alignment apparatus includes sequentially positioning the optical components on the alignment apparatus and positioning a bonding medium between at least a portion of adjacent optical components.

35. The method of claim 31, wherein aligning at least one edge of the optical components includes driving an edge of the optical components against an alignment member that is immobilized relative to a base.

36. The method of claim 31, wherein aligning at least one edge of the optical components includes positioning the optical components between alignment members and moving an alignment member so as to drive the at least one edge of the optical components against another alignment member.

37. A system for holding a block of optical components, comprising:
a base having a recess configured to receive the block of optical components, the bottom of the recess extending to an external side of the base; and
a cover configured to be positioned over the recess so as to clamp the block of optical components between the cover and the base.

38. The system of claim 37, wherein the recess has a geometry that is complementary to a geometry of a portion of the block of optical components.

39. The system of claim 37, wherein a bottom of the recess is positioned at an angle relative to a longitudinal axis of the holder, the angle being at least 1 degree.

40. The system of claim 39, wherein the angle is about 2 to 15 degrees.

41. The system of claim 37, wherein a side of the recess is positioned at an angle relative to a longitudinal axis of the holder, the angle being at least 1 degree.

42. The system of claim 41, wherein the angle is about 2 to 15 degrees.

43. The system of claim 37, further comprising:
a plurality of optical components formed into a block positioned in the recess such that a portion of the block extends from the recess.

44. The system of claim 37, wherein the recess is shaped such that the portion of the block extending from the recess includes a side of the block that is angled relative to a longitudinal axis of the holder, the angle being less than ninety degrees.

45. The system of claim 44, wherein the angle is about 88 to 75 degrees.
